(19) United States
(12) Patent Application Publication
(10) Pub. No.: US 2013/0335884 A1
(43) Pub. Date: Dec. 19, 2013

(54) CARBON SUPERCAPACITOR

(71) Applicants: Sergei Pavlovich Gubin, Moscow (RU); Andrei Valerievich Cheglakov, Mosco (RU); Pavel Nikolaevich Chuprov, Moscow (RU); Mark Mikhailovich Geller, Moscow (RU); Valerii Borisovich Dudakov, Moscow (RU); Andreas Alexandrovich Arshakuni, Moscow (RU); Nikolai Ivanovich Chistyakov, Moskovskaya obl. (RU); Denis Viktorovich Kornilov, Stavropolskii krai (RU); Ekaterina Gennadievna Rustamova, Ivanovskaya obl. (RU)

(72) Inventors: Sergei Pavlovich Gubin, Moscow (RU); Andrei Valerievich Cheglakov, Mosco (RU); Pavel Nikolaevich Chuprov, Moscow (RU); Mark Mikhailovich Geller, Moscow (RU); Valerii Borisovich Dudakov, Moscow (RU); Andreas Alexandrovich Arshakuni, Moscow (RU); Nikolai Ivanovich Chistyakov, Moskovskaya obl. (RU); Denis Viktorovich Kornilov, Stavropolskii krai (RU); Ekaterina Gennadievna Rustamova, Ivanovskaya obl. (RU)

(21) Appl. No.: 14/002,075

(22) PCT Filed: Dec. 16, 2011
(86) PCT No.: PCT/RU2011/000990

§ 371 Date: Aug. 28, 2013

(30) Foreign Application Priority Data
Jul. 14, 2011 (RU) 2011129188

(51) Int. Cl. H01G 11/32

(52) U.S. Cl. CPC H01G 11/32
USPC 361/502

(57) ABSTRACT

The invention relates to the field of electrochemical capacitors and, in particular, electrochemical supercapacitors. More specifically, the invention is directed towards the production of an electrochemical supercapacitor with an electric double layer, in which the energy accumulators and electrodes consist exclusively of materials based on various forms of carbon. The carbon supercapacitor comprises: a hermetic housing; substrate electrodes made from a carbon-containing material and provided with discrete, highly porous accumulation layers; separators made from a porous dielectric material in the form of a film, which separate the substrate electrodes; current collectors for the above-mentioned discrete, highly porous accumulation layers; and also external switching electrodes in the form of strips. The substrate electrode accumulation layers, the separators, the electric current collectors and the switching electrodes are made from carbon material and/or carbon-containing material.

The invention relates to electrochemical capacitors, and in particular, electrochemical supercapacitors. More specifically, the invention is directed to creation of the electrochemical supercapacitor with electric double layer, where the exclusively carbon-based materials in various forms are used as the energy storage devices and electrodes.

The advantages of supercapacitors as energy sources, compared with the batteries are well known: the significantly less time for recharge, as well as amount of withstand charge-discharge cycles is much greater.

The main difference of supercapacitor from a battery is that accumulation and output of electric power is conducted not due to electrochemical reactions like in the battery. Energy accumulation acts in the electric double layer on the capacitor's negative electrode. The operating voltage of the majority of supercapacitors is 1.2-2.5 V. They withstand the short-term over-voltage well.

At the same time, the majority of existing designs of supercapacitors have some drawbacks limiting their broad application.

Double electric layer supercapacitor (DELS) consists of a pair of electrodes divided by a separator, between which aqueous, non-aqueous or polymeric electrolyte is located. The electrodes are composed of an active material (usually activated carbon) and the electric current collector in a form of metal plate (usually copper) to which the active material is attached. The current collector and active material are immersed in electrolyte and during the supercapacitor operation they are subject to corrosion, especially at the boundaries of dissimilar materials. This leads to decomposition of the electrolyte and the relatively low temporal reliability of the supercapacitors.

The use of more corrosion-resistant metals, in particular noble ones leads to a significant increase of the device cost.

A carbon supercapacitor (ionistor) included in the state of the art, comprises: sealed casing; substrate electrodes of a carbonaceous material, equipped with discrete cumulative highly porous layers, separator of porous dielectric material film which separate the substrate-electrodes; electric current collectors of the above-mentioned discrete highly porous layers and external band-shaped switching electrodes (see the Internet, http://ru.wikipedia.org/wiki/ [symbol] , 28.05.2011.)

The disadvantages of this carbon supercapacitor (ionistor) included in the state of the art are following:
Low volumetric efficiency;
A relatively high weight and dimensions;
Low fire and corrosion resistance;
The high process cost with relatively low service life (number of charge cycles.)

The technical result of declared technical solution is a significant improvement in the basic physical and chemical (operating) parameters of declared subject, namely:
provision of a high surface area per unit weight of activated carbon in many physical and chemical conditions and, as a consequence, the ability to accumulate a larger amount of charged particles (ions) as compared with the known analogs;
low reactivity/both chemical and electrochemical/in the electrolytic medium;
high electrical conductivity;
high temperature resistance combined with low oxidation ability in active oxidizing environment;
low thermal conductivity and low specific weight.

At the least, even those already studied physical and chemical properties (parameters) of declared technical solution provide it with ample operational and process opportunities in various fields of engineering, particularly in the development of environmentally friendly electric drive vehicles.

The stated technical result is ensured by the fact that the carbon supercapacitor, comprising: sealed casing; substrates of a carbonaceous electrode material, equipped with discrete cumulative highly porous layers, separator of porous dielectric material film which separate the substrate-electrodes; electric current collectors of the above-mentioned discrete highly porous layers and external band-shaped switching electrodes according to the invention, the cumulative layers of substrate electrodes, separators, current collectors and external switching electrodes are made of carbon and/or carbonaceous materials.

It is reasonable that the substrate electrodes were made of:
extruded thermally expanded graphite film with a specific gravity 0.9-1.4 g/cm³;
extruded thermally expanded graphite film with integrated conductive carbon fiber mesh;
fabrics formed on the basis of conductive carbon fibers;
plates of compacted graphite powder;
conductive porous film with pores filled with finely dispersed carbon composition.

It is optimally that the cumulative layers of substrate electrodes were made of finely dispersed carbon powder joined by the bonding compound.

It is reasonable that following materials used as the discrete cumulative highly porous layers:
graphite foam;
activated carbon with area of the active absorbent surface of 600-3,600 m²/g;
fullerene;
graphene;
carbon nano-tubes.

A carbon black may also be used as the material for the discrete cumulative highly porous layers of the substrate electrodes.

It is reasonable that the polypropylene film was used as separators dividing the substrate electrodes (made of porous, film-type dielectric material).

Conductive strips of the electric current collector and external switching electrodes may be made of:

compacted graphite powder;
extruded graphite foam film (i.e., carbonized paper);
The most reasonable is that a sealed casing of the supercapacitor was made of high strength corrosion resistant plastic.

Analysis of the stage of the art conducted by the applicant, including the search over the patent and scientific and technical information sources and sources that contain information concerning the analogs of declared technical solution, allowed to establish that there are no any analogs found, characterized by features and interconnections, the same or equivalent to all the essential features of the declared technical solution, and the prototype selected from the detected analogs (as the analog most similar by a set of features) has allowed to identify a set of significant (relating to the technical result perceived by the applicant) distinguishing features in the declared subject contained in the formula.

Consequently, the declared technical solution complies with requirements of the patentability of “novelty” under the applicable legislation.

To verify the compliance of the declared technical solution with requirements of conditions for the patentability “inventive step”, the applicant has performed an additional search for prior art, in order to detect the features that coincide with the features of the declared technical solution distinctive to the prototype, the results of which show that the declared technical solution does not results (for professionals) obviously from the prior art, since the art (as defined by the applicant) did not revealed any effect provided by the essential features of the declared technical solution to achieve the technical result perceived by the applicant.

In particular, the declared technical solution does not provide following transformations of prior prototype art:
addition of prior art with any known feature attached hereto according to known rules, to achieve a technical result in respect of which the influence of these additions is established;
replacement of any feature of prior art by other known feature in order to achieve a technical result, in respect of which the influence of such a change is established;
exclusion of any feature of the prior art while excluding of a function characterized by the presence of this feature and simultaneous achievement of a result normal for such an exclusion;
increase of number of similar features in the prior art to achieve the technical result due to the presence of just such features in the art;
making the prior art or its part of a known material to achieve the technical result due to known material's properties;
creation of an art including known features which are selected and interrelated based on known rules, and the technical result achieved in this case is characterized by known properties of this art's features and appropriate relations.

Hence, declared technical solution complies with requirement of the patentability of “level of invention” under the applicable legislation.

Weight characteristics of the devices play an important role when using the supercapacitors Improving the energy density and power per 1 kg of weight unit is an urgent task. The main way to solve it is using of lighter materials in all structural elements while maintaining the basic electrical parameters of the device.

Supercapacitors as sources of high-power electric pulses at high current loads are subject to stringent fire safety requirements. Should the organic solvents used in the electrolytes, the presence of sparking or local overheating at boundaries of dissimilar materials can lead at the high load currents to temperature overload and the device ignition.

Newly created large-usage devices are subject to increased environmental requirements, particularly in the case of a technical accident or recovery of the failed device.

The main direction of solving this problem is reducing the number of environmentally harmful components in the materials of supercapacitor.

According to abovementioned the materials used to create a supercapacitor, can affect its parameters, such as:
maximum operating voltage;
operating temperature;
consistency of operation;
set electrolytes which can be used;
service life, cost, safety and disposal.

Considering the above limitations, the present invention proposes to replace a variety of different materials used to form capacitors by the homogeneous carbon-based materials.

Currently a wide range of materials differing by morphology and physical properties is created on the basis of carbon. There are materials among them with a metal (or approximate thereto) conductivity (graphene, carbon nano-tubes, graphite and its products, carbon black) and dielectrics (polyethylene and other plastics).

All the elements of supercapacitor may be formed based on these materials.

Carbon materials are chemically inert and heat-resistant.

Following positive application properties of carbon and/or carbonaceous materials contained in the supercapacitor shall be noted:
high specific surface area per unit weight of activated carbon in many physical and chemical states, and as a result, the ability to accumulate a large amount of ions;
low reactivity (chemical and electrochemical activity) in the electrolytic medium;
relatively high electrical conductivity;
high temperature resistance combined with low oxidation ability in the active oxidizing environment;

low thermal conductivity and low specific weight.

Essence of invention (available to those skilled in the field) discloses with more detailed description of the declared technical solution and specific (stated below) examples of its industrial implementation (which, i.e. examples, however, do not limit the declared range all claims within the scope of the provided technical solution formula).

Carbon supercapacitor includes: sealed casing; substrate electrodes of a carbonaceous material, equipped with discrete cumulative highly porous layers, separator of porous dielectric material film which separate the substrate-electrodes; electric current collectors of the above-mentioned discrete highly porous layers and external band-shaped switching electrodes. Thus, cumulative layers of the substrate electrodes, separators, electric current collectors and external switching electrodes are made of carbon and/or carbonaceous materials.

It is reasonable that the substrate electrodes were made of:
extruded thermally expanded graphite film with a specific gravity 0.9-1.4 g/cm³ (this provides increasing of thermal stability, reducing of integrated resistance and, thus increasing of reliability);
extruded thermally expanded graphite film with integrated conductive carbon fiber mesh (this provides reducing of integrated resistance and, thus increasing of reliability);
fabrics formed on the basis of conductive carbon fibers (this provides reducing of weight and dimensions);
plates of compacted graphite powder (this provides reducing of weight and dimensions);
conductive porous film with pores filled with finely dispersed carbon composition (this provides reducing of cost, weight and dimensions).

It is optimally that the cumulative layers of substrate electrodes were made of finely dispersed carbon powder joined by the bonding compound (this provides achieving of maximum specific capacity).

It is reasonable that following materials used as the discrete cumulative highly porous layers of substrate electrodes:
graphite foam (this provides reducing of cost, weight and dimensions);
activated carbon with area of the active absorbent surface of 600-3,600 m²/g (this provides reducing of cost, weight and dimensions);

fullerene (this provides reducing of weight and dimensions);
graphene (this provides reducing of cost, weight and dimensions);
carbon nano-tubes (this provides reducing of weight and dimensions).

A carbon black may also be used as the material for the discrete cumulative highly porous layers of the substrate electrodes (this provides reducing of weight and dimensions).

It is reasonable that a polypropylene film was used as separators dividing the substrate electrodes (made of porous, film-type dielectric material) (this provides reducing of cost, weight and dimensions, as well as increasing of specific capacity).

Conductive strips of the electric current collectors and external switching electrodes can be made of:
compacted graphite powder (this provides reducing of cost, weight and dimensions, as well as increasing of specific capacity);
extruded graphite foam film i.e. carbonized paper (this provides reducing of cost, weight and dimensions, as well as increasing of specific capacity);

The most reasonable is that a sealed casing of the supercapacitor was made of high strength corrosion resistant plastic (this provides minimal weight of the supercapacitor while maintaining the maximum strength).

### EXAMPLE 1

Carbon supercapacitor is made with the substrate electrodes in the form of plates of sliced expanded graphite foil brand: foil GF-100-0.2/1.0-400, made according to the specifications TU 5728-003-93978201-2008. Dimensions of substrate electrodes are selected following: 150×300 mm² The long edge of each substrate electrode includes six holes perforated with a diameter of 4 mm Both sides of each of 100 substrate electrodes include formed cumulative layer with a thickness of 150 micron made of a following cumulative mixture: steam activated graphite powder with an average grain size of 40 micrometers in an amount of 70-90% by weight of the mixture; fullerene powder in an amount of 5-10% by weight of the entire mixture; conductive carbon black powder in an amount of 5-10% by weight of the entire mixture; the aqueous solution of the carboxy-methyl cellulose sodium salt (Na-CMC) in an amount of no more than 5% by weight of the entire mixture.

After applying of viscous flowing mixture the substrate electrodes were subject to photonic thermal drying under the halogen lamps in air at 80° C. within 20 min

Then dried substrate electrodes were sequentially collected in the supercapacitor block packet on the slipway (electrically isolated from the substrate electrodes and screws) with two opposite rows of clamping screws of dielectric material which are passed through holes perforated in the electrode substrates. The polypropylene separator film with a thickness of 25 microns was laid between the substrate electrodes. The electric current collector is put on each raw of screws that is represented by a strip of TEG brand GF-300 -0.2/1.0-400. Moreover, the ends of these collectors extend beyond the plates of substrate electrodes. After assembly of all 100 substrate electrodes, the sealing mandrel was installed on the last substrate electrode that was dielectrically isolated from screws and plates and substrate electrodes.

Then, the assembly (a set of substrate electrodes and separators of the supercapacitor's block) are crimped using screws by sealing and stacking mandrels. Overhang collectors are electrically connected into two external output (external switching electrodes) of the supercapacitor. Supercapacitor block is placed in a plastic housing sealed with a cover. At air is evacuated from the housing by backing pump via the exhaust valve and a supercapacitor under a vacuum is dried at a temperature of 80° C. within 2 hours. Then the aprotonic lithium-containing electrolyte is fed through the inlet valve into the body of the supercapacitor containing, for example LiPF₆. The capacitor is impregnated by electrolyte within 2 hours. Ready supercapacitor is tested with the measurement of the current-voltage characteristics on the computer test-bench.

### EXAMPLE 2

Carbon supercapacitor structurally and technologically performed similarly to the Example 1 with following differences.

Composition of cumulative mixture: thermally activated graphite powder with an average grain size of 40 micrometers in an amount of 70-90% by weight of the whole mixture; fullerene powder in an amount of 5-10% by weight of the whole mixture; conductive carbon black powder in an amount of 5-10% by weight of the whole mixture and the 2-Teflon solution in dimethylformamide (DMF) with 2-Teflon content no more than 5% by weight of the whole mixture.

### EXAMPLE 3

Carbon supercapacitor structurally and technologically performed similarly to the Example 1 with following differences.

Composition of cumulative mixture: activated carbon powder with a total surface area of 600 m²/g and an average grain size of 25 micrometers in an amount of 70-90% by weight of the whole mixture; fullerene powder in an amount of 5-10% by weight of the whole mixture, conductive carbon black powder in an amount of 5-10% by weight of the whole mixture, an alcohol-water solution with alcohol content of 10-20% by the volume of water and Na-CMC of not more than 5% by weight of the whole mixture.

### EXAMPLE 4

Carbon supercapacitor structurally and technologically performed similarly to the Example 1 with following differences.

Composition of cumulative mixture: activated carbon powder with a total surface area of 2,200-3,000 m²/g, obtained by alkaline thermal treatment of rice husk.

### EXAMPLE 5

Carbon supercapacitor structurally and technologically performed similarly to the Example 1 with following differences. Substrate electrodes are made of graphite paper with density of 0.5-1.5 g/cm³.

### EXAMPLE 6

Carbon supercapacitor structurally and technologically performed similarly to the Example 1 with following differences.

Substrate electrodes are made of conductive carbon fabric.

### EXAMPLE 7

Carbon supercapacitor structurally and technologically performed similarly to the Example 1 with following differences.

Connections (electric current collectors) of the substrate electrodes are made of conductive carbon fabric.

### EXAMPLE 8

Carbon supercapacitor structurally and technologically performed similarly to the Example 1 with following differences.

Connections (electric current collectors) of the substrate electrodes are made of graphite paper with density of 0.5-1.5 g/cm³.

### EXAMPLE 9

Carbon supercapacitor structurally and technologically performed similarly to the Example 1 with following differences.

The strips of electric current collectors have been removed from the structure of the supercapacitor. The electrical connection between the substrate electrode plates with external terminals (switching electrodes) of the capacitor, along the long sides of the substrate electrodes' block there are two monolithic collectors made of a conductive rectangular carbon blocks. Moreover, these carbon block- collectors fit snugly against the ends of the substrate electrodes and are electrically connected to the external terminals (whereby each collector has corresponding external terminal). This design allows increasing the reliability and thermal stability of the supercapacitor.

Thus, the technical result of the declared technical solution is expanding of the inventive subject matter's functionality with a significant improvement of operating parameters (see Table 1).

Therefore, the above data certify, that when using the declared technical solution, the following set of conditions will be met:
the subject embodying the declared technical solution whether it will be implemented, is designed for industrial use, namely, to produce the electric energy by environmentally friendly method;
for the declared subject in the form as it is characterized in the independent paragraph of the following formula the possibility is confirmed of its application using the means and methods above-described herein or known from the prior art at the priority date;
the subject embodying the declared technical solution whether it will be implemented, is able to provide achievement of technical result perceived by the applicant.

Consequently, the declared technical solution meets the requirement of patentability of “industrial applicability” under the applicable legislation.

TABLE 1
Technical parameters of carbon supercapacitor

| | | SC section | Full-size SC |
|---|---|---|---|
| Parameters of carbon supercapacitor | | (100 | battery |
| The specific SC capacitance | F/g | 140-200 | 160-250 |
| divided by the mass of the | | | |
| electrode | | | |
| Peak pulse power of IC | kW | 1.5-3 | 45-60 |
| discharge for 10 seconds | | | |
| The energy at power of | kW/h | 0.4-0.8 | 10-18 |
| 10 kW in discharge mode | | | |
| Maximum weight | kg | 0.5-0.8 | 10.5-18 |
| Maximum volume | l | 1 | 10 |
| Recharge rate at 30° C., | s | 0.7-1.2 | 1.0-3.0 |
| 36 V | | | |
| Number of recharges | 70-80% | 10⁵-10⁶ | 10⁶-10⁷ |
| | discharge | | |
| Service life | years | 10 | 10 |

1-17. (canceled)

18. A carbon supercapacitor, comprising:
a sealed casing;
substrate electrodes of a carbonaceous material, the substrate electrodes having discrete cumulative highly porous layers, and a separator of porous dielectric material film separating the substrate electrodes; and
electric current collectors of the discrete highly porous layers and external band-shaped switching electrodes;
wherein the cumulative layers of substrate electrodes, separators, current collectors and external switching electrodes are made of carbon or carbonaceous materials.

19. The supercapacitor according to claim 18, wherein the substrate electrodes are made of extruded thermally expanded graphite film with a specific gravity 0.9-1.4 g/cm³.

20. The supercapacitor according to claim 18, wherein the substrate electrodes are made of extruded thermally expanded graphite film with integrated conductive carbon fiber mesh.

21. The supercapacitor according to claim 18, wherein the substrate electrodes are made of fabrics formed from conductive carbon fibers.

22. The supercapacitor according to claim 18, wherein the substrate electrodes are made of plates of compacted graphite powder.

23. The supercapacitor according to claim 18, wherein the substrate electrodes are made of conductive porous film with pores filled with a finely dispersed carbon composition.

24. The supercapacitor according to claim 18, wherein the cumulative layers of substrate electrodes are made of finely dispersed carbon powder joined by a bonding compound.

25. The supercapacitor according to claim 18, wherein a graphite foam is used as a material for the discrete finely dispersed cumulative layers of the substrate electrodes.

26. The supercapacitor according to claim 18, wherein an activated carbon with an area of active absorbent surface in the range of 600-3,600 m²/g is used as a material for the discrete finely dispersed cumulative layers of the substrate electrodes.

27. The supercapacitor according to claim 18, wherein fullerene is used as a material for the discrete finely dispersed cumulative layers of the substrate electrodes.

28. The supercapacitor according to the claim 18, wherein carbon nanotubes are used as a material for the discrete finely dispersed cumulative layers of the substrate electrodes.

29. The supercapacitor according to claim 18, wherein graphene is used as a material for the discrete finely dispersed cumulative layers of the substrate electrodes.

30. The supercapacitor according to claim 18, wherein carbon black is used as a material for the discrete finely dispersed cumulative layers of the substrate electrodes.

31. The supercapacitor according to claim 18, wherein polypropylene film is used as separators dividing the substrate electrodes and are made of porous, film-type dielectric material.

32. The supercapacitor according to claim 18, wherein conductive strips of the electric current collectors and external switching electrodes are made of compacted graphite powder.

33. The supercapacitor according to claim 18, wherein conductive strips of the electric current collectors and external switching electrodes are made of extruded graphite foam film-carbonized paper.

34. The supercapacitor according to claim 18, wherein the sealed casing is made of high strength, corrosion resistant plastic.
